(19) United States
(12) Patent Application Publication
(10) Pub. No.: US 2005/0058801 A1
(43) Pub. Date: Mar. 17, 2005

(54) Optical disk and method of producing the same

(75) Inventors: Koji Tsujita, Yokohama-Shi (JP); Kenji Oishi, Yokohama-Shi (JP); Katsunori Ohshima, Kamakura-Shi (JP)

Correspondence Address: RENNER, KENNER, GREIVE,;BOBAK, TAYLOR & WEBER, Fourth Floor, First National Tower, Akron, OH, 44308-1456, US

(73) Assignee: Victor Company of Japan, Ltd.

(21) Appl. No.: 10/938,195

(22) Filed: Sep. 10, 2004

(30) Foreign Application Priority Data
Sep. 12, 2003 (JP) 2003-321846
May 31, 2004 (JP) 2004-161561
Jul. 30, 2004 (JP) 2004-223713

(51) Int. Cl. B41M 5/00

(52) U.S. Cl. 428/64.4

(57) ABSTRACT

An optical disk has a first intermediate disk structure and a second intermediate disk structure. The first intermediate disk structure has at least a first optically-transparent substrate and a first recording layer, laminated in order. The second intermediate disk structure has at least a second substrate, a reflective layer, a second recording layer and an optically-transparent-resin thin-film layer, laminated in order. The second recording layer has an organic dye soluble in an alcohol solution or a Cellosolve solution. The optically-transparent-resin thin-film layer has a thermoplastic resin that is softened and deformed at a particular temperature or lower at which the organic dye of the second recording layer is decomposed when absorbing an irradiated laser beam in recording. The first and the second intermediate disk structures are stuck to each other via an optically-transparent adhesive layer as the first recording layer and the optically-transparent-resin thin-film layer face each other via the adhesive layer in which the optically-transparent-resin thin-film layer directly comes into contact with the adhesive layer.

### BACKGROUND OF THE INVENTION

The present invention relates to a high-density optical disk and a method of producing such an optical disk. Particularly, this invention relates to an optical disk having at least two recording layers between two substrates stuck to each other.

Optical disks have recently been in widespread use. Among optical disks, read-only compact disks, such as, CD-Audio and CD-ROM, have been produced in large number as storage media for music, data bases, computer programs, and so on.

Other compact disks developed as compatible with such read-only compact disks are user-writable disks. Among user-writable disks, write-once compact disks (CD-R) have recently been produced in large number because CD-R can be played back on any type of CD players and CD drives.

Another type of optical disk that has been used widely and rapidly is a read-only (ROM-type) digital versatile disk (DVD) having a storage capacity of 4. 7 giga bytes (GB) seven times larger than 640 GB for CD.

A new version of ROM-DVD recently standardized and produced in large number is a one-side read-only dual-layer DVD (so-called DVD dual layer) with two substrates stuck to each other. It has a storage capacity of 8. 5 GB for storing content of 4. 7 GB or higher, such as movies.

Still other types of writable optical disk in widespread use now are a write-once DVD (DVD-R) and a rewritable DVD (DVD-RAM and DVD-RW) for use in verification and backup in production of DVD-ROM. DVD-R and DVD-RAM have a storage capacity of 4. 7 GB because they have one recording layer.

Other types of DVD-R and DVD-RW now on the market have a storage capacity of 9. 4 GB. These media are a dual-layer type in which two 0. 6-mm thick DVD-R or DVD-RW disks are stuck to each other. In other words, two disks each having one recording layer are stuck to each other. This causes inconvenience such that this type of disk must be ejected from a CD player and turned over in recording or playback on both of two recording layers.

Thus, there is a demand for dual-layer optical disks for one-side recording and reproduction, like the one-side read-only dual-layer DVD (DVD dual layer).

Japanese Unexamined Patent Publication No. 2001-266402 discloses a dual-layer optical disk for one-side recording and reproduction, having two AgInSbTe phase-change recording layers.

Phase-change recording layers, however, exhibit low reflectivity. The standard specification defines reflectivity in the range from 18% to 30% against laser beams for both of a first recording layer (L0) and a second recording layer (L1) of the read-only dual-layer DVD (DVD dual layer). Optical disks having the phase-change recording layers as the layers L0 and L1 thus cannot be played back on existing DVD players that have already been shipped and used widely in large numbers, due to low reflectivity of the phase-change recording layers.

Japanese Unexamined Patent Publication Nos. 2000-99991, Heisei 8 (1996)-315415, and 2000-82238 disclose optical disks for one-side recording and reproduction, having a phase-change recording layer as the layer L0 and an organic-dye and metallic-reflective recording layer as the layer L1, for higher reflectivity of the layer L1.

This type of optical disk is produced as follows: a phase-change recording layer is formed on an optically-transparent substrate; a metallic reflective layer and then an organic dye layer are formed on another optically-transparent substrate; and the two optically-transparent substrates are stuck to each other with an ultraviolet (UV) cure adhesive.

One example of this type of optical disk is illustrated in FIG. 1. The optical disk shown in FIG. 1 has a first optically-transparent substrate 2, a phase-change recording layer (the layer L0) 4, an adhesive layer 6, an organic-dye recording layer (the layer L1) 8, a metallic reflective layer 10, and a second substrate 12, laminated in order. In recording or reproduction, a laser beam L is incident to the first optically-transparent substrate 2.

The adhesive layer 6 and the organic-dye recording layer 8 come into contact with each other, as shown in FIG. 1, when the substrates 2 and 12 are stuck to each other with a UV cure adhesive after the phase-change recording layer 4 was formed on the substrate 2, and the metallic reflective layer 10 and the organic-dye recording layer 8 on the substrate 12.

A dye to be used for the organic-dye recording layer (the layer L1) 8 is made from an organic dye, such as cyanine, phthalocyanine or azoic dye, decomposed in an alcohol or a Cellosolve organic solution of relatively high polarity, for higher reflectivity of the recording layer, like CD-R and DVD-R with a single recording layer.

A material to be used for the adhesive layer 6 is usually an acryrate UV cure resin for high productivity and yielding. Main ingredients of this rein are epoxyacryrate, urethanacryrate, and the mixture of these materials.

A characteristic of the acryrate UV cure resin is to dissolve an organic dye partially or entirely. It could thus happen that, when the substrates 2 and 12 are stuck to each other via the adhesive layer 6, the organic-dye recording layer 8 is dissolved and mixed with the layer 6, which results in that the layer 8 is damaged partially or entirely, thus not functioning as a recording layer.

For the purpose of protecting a dye recording layer, Japanese Unexamined Patent Publication No. 2000-339766 discloses an optical disk having an organic-dye recording layer and a polyvinyl-alcohol protective layer formed thereon. The protective layer is formed by spin coating the recording layer with a polyvinyl-alcohol solution. The organic-dye recording layer is protected by the protective layer from being dissolved in a UV cure resin in disk bonding.

Japanese Unexamined Patent Publication No. Heisei 11 (1999)-66622 discloses an optical disk having an organic-dye recording layer directly coated with monomethyl siloxane. Before coating, monomethyl siloxane is dissolved in a solution in which an organic dye is insoluble. The coated recording layer is then hardened in disk bonding.

Japanese Patent Publication No. Heisei 7 (1995)-118097 discloses an optical disk bonded with a hot-melt adhesive including a thermoplastic elastomer and a tackifier.

Japanese Unexamined Patent Publication No. 2000-311384 discloses an optical disk having an inorganic-metal barrier layer for protecting an organic-dye recording layer.

The optical disk disclosed in Japanese Unexamined Patent Publication No. 2000-339766 has the polyvinyl-alcohol protective layer formed by spin coating the organic-dye recording layer with the polyvinyl-alcohol solution, with moisture removal. This optical disk is thus disadvantageous in that: moisture is slow to evaporable, thus causing long protective-layer formation i. e. a lot of moisture remaining in polyvinyl alcohol requires baking in protective-layer formation; and polyvinyl alcohol is highly hygroscopic which causes low transparency after protective-layer formation with baking.

The optical disk disclosed in Japanese Unexamined Patent Publication No. Heisei 11 (1999)-66622 is disadvantageous in that: disk bonding requires hardening of monomethyl siloxane at a high temperature, resulting in long disk production time; and the high temperature causes disk warpage and deformation.

Ordinary optical disks with an organic-dye recording layer have a structure in which this recording layer is formed on a substrate of a thermoplastic resin such as a polycarbonate resin.

The recording mechanism for such ordinary optical disks is as follows: when irradiated with a laser beam in recording, not only changing in optical characteristics, but also the organic dye absorbs energy of the laser beam to generate heat, thus deforming a part of the substrate thermoplastic resin, or creating cavities thereon, for bigger change in reflectivity of recorded marks, or larger modulation factor.

At least one of the layers coming into contact with the organic-dye recording layer is preferably a thermoplastic resin rather than a cure resin or an elastomer. This is because the one particular layer coming into contact with the recording layer is softened to deform due to heat generated by dye decomposition for higher contrast of recorded marks.

In contrast, optical disks having a reflective layer, an organic-dye recording layer, a cure adhesive layer laminated in order on a thermoplastic-resin substrate hardly suffer deformation of the substrate or the adhesive layer which otherwise occur due to heat of decomposition of the organic dye. This is because the thermoplastic-resin substrate is separated from the organic-dye recording layer by the reflective layer made of a cure resin. These optical disks thus suffer low contrast and small modulation factor on recorded marks.

Moreover, optical disks having an organic-dye recording layer between a reflective layer and a protective layer both made of an inorganic metal suffer from low recording sensitivity due to easy leakage of heat generated by decomposition of the organic dye when absorbing a laser beam in recording. This is because an inorganic-metal layer exhibits extremely higher thermal conductivity than an organic layer of plastic, etc. The organic-dye recording layer in this type of optical disk does not directly come into contact with a thermoplastic resin, which causes small deformation of recorded marks and thus adverse recording characteristics.

### SUMMARY OF THE INVENTION

A purpose of the present invention is to provide an optical disk having at least two organic-dye recording layers that exhibits high reflectivity and large modulation factor with no damage to the recording layers when bonded and can be played back on known DVD players, and a method of producing such optical disk.

The present invention provides an optical disk comprising: a first intermediate disk structure having at least a first optically-transparent substrate and a first recording layer, laminated in order; a second intermediate disk structure having at least a second substrate, a reflective layer, a second recording layer and an optically-transparent-resin thin-film layer, laminated in order, the second recording layer having an organic dye soluble in an alcohol solution or a Cellosolve solution, the optically-transparent-resin thin-film layer having a thermoplastic resin that is softened and deformed at a particular temperature or lower at which the organic dye of the second recording layer is decomposed when absorbing an irradiated laser beam in recording; and an optically-transparent adhesive layer, the first and the second intermediate disk structures being stuck to each other via the adhesive layer as the first recording layer and the optically-transparent-resin thin-film layer face each other via the adhesive layer in which the optically-transparent-resin thin-film layer directly comes into contact with the adhesive layer.

Moreover, the present invention provides a method of producing an optical disk comprising the steps of: forming at least a first recording layer on a first optically-transparent substrate to form a first intermediate disk structure; forming at least a reflective layer and a second recording layer in order on a second substrate; spin coating the second recording layer with an optically-transparent-resin thin-film layer having a thermoplastic resin that is softened and deformed at a particular temperature or lower at which the second recording layer is decomposed when absorbing an irradiated laser beam in recording, to form a second intermediate disk structure having the second substrate, the reflective layer, the second recording layer and the optically-transparent-resin thin-film layer, laminated in order; and bonding the first and the second intermediate disk structures each other via an optically-transparent adhesive layer so that the first recording layer and the optically-transparent-resin thin-film layer face each other via the adhesive layer in which the optically-transparent-resin thin-film layer directly comes into contact with the adhesive layer.

### BRIEF DESCRIPTION OF DRAWINGS

FIG. 1 is a cross-sectional view of a known optical disk;

FIG. 2 is a cross-sectional view of an embodiment of an optical disk according to the present invention;

FIG. 3 is a cross-sectional view of a first intermediate disk structure of the optical disk shown in FIG. 2;

FIG. 4 is a cross-sectional view of a second intermediate disk structure of the optical disk shown in FIG. 2;

FIG. 5 is a cross-sectional view of a sample optical disk according to the present invention;

FIG. 6 is a cross-sectional view of a first intermediate disk structure of the sample optical disk shown in FIG. 5;

FIG. 7 is a cross-sectional view of a sample optical disk according to the present invention;

FIG. 8 is a cross-sectional view of a second intermediate disk structure of the sample optical disk shown in FIG. 7;

FIG. 9 is a cross-sectional view of a first intermediate disk structure in a comparative sample;

FIG. 10 is a cross-sectional view of a second intermediate disk structure in a comparative sample;

FIG. 11 is a graph indicating spectral characteristics of the first intermediate disk structure shown in FIG. 9;

FIG. 12 is a graph indicating spectral characteristics of the second intermediate disk structure shown in FIG. 10;

FIG. 13 a graph indicating spectral characteristics of a sample second intermediate disk structure according to the present invention; and

FIG. 14 is an enlarged cross-sectional view of an upper-half disk (such as shown in FIG. 4) including a second recording layer that is apart from the light-incident plane, in a dual-layer optical disk according to the present invention.

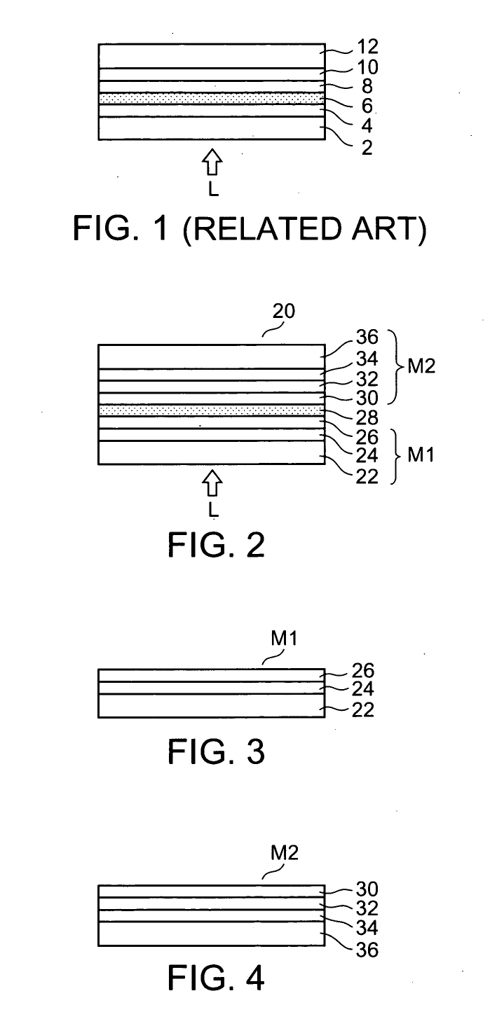

### DETAILED DESCRIPTION OF PREFERRED EMBODIMENTS

Embodiments of an optical disk and a disk production method according to the present invention will be disclosed with reference to the attached drawings.

The same reference signs or numbers are given to the identical or analogous components of optical disks, such as a substrate and a recording layer, throughout the specification and drawings.

Illustrated in FIG. 2 is an embodiment of an optical disk according to the present invention.

An optical disk 20 shown in FIG. 2 is provided with a first optically-transparent substrate 22, a first organic-dye recording layer 24, a first optically-transparent-resin thin-film protective layer 26 made of a thermoplastic resin, an optically-transparent adhesive layer 28, a second optically-transparent-resin thin-film protective layer 30 made of a thermoplastic resin, a second organic-dye recording layer 32, a metallic-film reflective layer 34, and a second substrate 36, laminated in order.

The structural feature of the optical disk shown in FIG. 2 is that the first optically-transparent-resin thin-film protective layer 26 made of a thermoplastic resin is formed between the first organic-dye recording layer 24 and the optically-transparent adhesive layer 28, and the second optically-transparent-resin thin-film protective layer 30 made of a thermoplastic resin is formed between the second organic-dye recording layer 32 and the adhesive layer 28.

In this structure, the optically-transparent adhesive layer 28 does not come into contact with the first and the second organic-dye recording layers 24 and 32 so that the recording layers are protected from damage by the adhesive layer.

Moreover, when the first and the second organic-dye recording layers 24 and 32 are irradiated with a laser beam in recording, parts of the first and the second optically-transparent-resin thin-film protective layers 26 and 30 are deformed for larger modulation factor.

As shown in FIG. 2, a laser beam L is incident in the first optically-transparent substrate 22 in recording or reproduction through a light-incident plane (the bottom surface in FIG. 2) of the substrate 22.

The first and the second optically-transparent-resin thin-film layers 26 and 30 are made of a thermoplastic resin so that they can function as protective layers for the first and the second organic-dye recording layers 24 and 32, respectively. The first layer 26 on the light-incident side may, however, be a semi-transparent metallic protective layer or an inorganic transparent thin-film layer.

Disclosed next is a method of producing the optical disk 20 having a first intermediate disk structure M1 and a second intermediate disk structure M2, as shown in FIG. 2.

### Production of First Intermediate Disk Structure M1

As shown in FIG. 3, formed on a first optically-transparent substrate 22 having pre-grooves on the surface thereof is a first organic-dye recording layer 24. The recording layer 24 is formed by spin coating the substrate 22 with an organic dye dissolved in an alcohol solution. The pre-grooves can be formed by any known technique.

Formed on the first organic-dye recording layer 24 is a first optically-transparent-resin thin-film protective layer 26 used for protecting the recording layer 24. The protective layer 26 is formed by spin coating the recording layer 24 with an optically-transparent resin dissolved in a nonpolar solution.

Finished through the steps disclosed above is the first intermediate disk structure M1 having the first optically-transparent substrate 22, the first organic-dye recording layer 24, and the first optically-transparent-resin thin-film protective layer 26, laminated in order, as shown in FIG. 3.

The material for the first optically-transparent substrate 22 is any material to be used for ordinary optical-disk substrates, such as, a polycarbonate resin, a polymethacrylic ester resin, or an amorphous polyolefin resin.

Not only an optically-transparent-resin thin-film layer made of a thermoplastic resin, but also a semi-transparent metallic reflective layer or an inorganic transparent thin-film layer can be used as the protective layer 26 in the first intermediate disk structure M1.

An organic dye to be used for the first recording layer 24 is preferably cyanine, phthalocyanine or azoic dye which is soluble in a polar solution, especially, an alcohol or a Cellosolve solution.

The transparent resin to be used for the first optically-transparent-resin thin-film protective layer 26 must be a resin that is soluble in a particular solution that does not dissolve the organic dye used for the first recording layer 24.

Such a particular solution that does not dissolve an organic dye is preferably a nonpolar solution, for example, Cyclohexane, Tetralin or Decalin when cyanine, phthalocyanine or azoic dye soluble in an alcohol or a Cellosolve solution is used for the first organic-dye recording layer 24.

A transparent dye soluble in such a nonpolar solution is preferably an alicyclic hydrocarbon resin, a cyclo-olefin polymer or an amorphous cyclo-olefin copolymer (Zeonex® or Qinton® made by Zeon Co.).

### Production of Second Intermediate Disk Structure M2

As shown in FIG. 4, formed on a second substrate 36 having pre-grooves on the surface thereof is a metallic-film reflective layer 34. The reflective layer 34 is formed by a known vacuum film forming technique, such as, deposition or sputtering.

Formed on the metallic-film reflective layer 34 is a second organic-dye recording layer 32. The recording layer 32 is formed by spin coating the reflective layer 34 with an organic dye dissolved in an alcohol solution.

Formed on the second organic-dye recording layer 32 is a second optically-transparent-resin thin-film protective layer 30 made of a thermoplastic resin used for protecting the recording layer 32. The protective layer 30 is formed by spin coating the recording layer 32 with an optically-transparent resin dissolved in nonpolar solution.

Finished through the steps disclosed above is the second intermediate disk structure M2 having the second substrate 36, the metallic-film reflective layer 34, the second organic-dye recording layer 32, and the second optically-transparent-resin thin-film protective layer 30, laminated in order, as shown in FIG. 4.

The second substrate 36 may not be transparent because it is not subjected to laser irradiation, however, is preferably made of the same material as for the first optically-transparent substrate 22 in the first intermediate disk structure M1.

The metallic-film reflective layer 34 is preferably made of Au, Al, Ag or an alloy of any of these metals for higher reflectivity.

An organic dye to be used for the second recording layer 32 is preferably cyanine, phthalocyanine or azoic dye which is soluble in a polar solution, especially, an alcohol or a Cellosolve solution.

The transparent resin to be used for the second optically-transparent-resin thin-film protective layer 30 must be a resin that is soluble in a particular solution that does not dissolve the organic dye used for the second recording layer 32.

Such a particular solution that does not dissolve an organic dye is preferably a nonpolar solution, for example, Cyclohexane, Tetralin or Decalin when cyanine, phthalocyanine or azoic dye soluble in an alcohol or a Cellosolve solution is used for the second organic-dye recording layer 32.

A transparent dye soluble in such a nonpolar solution is preferably an alicyclic hydrocarbon resin, a cyclo-olefin polymer or an amorphous cyclo-olefin copolymer (Zeonex® or Qinton® made by Zeon Co.).

### Bonding of First and Second Intermediate Disk Structures M1 and M2

The first and the second intermediate disk structures M1 and M2 as produced above are stuck to each other to finish the optical disk shown in FIG. 2.

In detail, the second intermediate disk structure M2 is placed on the first intermediate disk structure M1 so that the first and the second optically-transparent-resin thin-film protective layers 26 and 30 face each other via the optically-transparent adhesive layer 28. The material for the adhesive layer 28 is preferably an acryrate UV cure resin for high productivity and yielding.

The two intermediate disk structures M1 and M2 are stuck to each other, preferably, by spin bonding. In detail, a UV cure resin is applied on either the first optically-transparent-resin thin-film protective layer 26 of the first intermediate disk structure M1 or the second optically-transparent-resin thin-film protective layer 30 of the second intermediate disk structure M2. The other intermediate disk structure is placed on the UV-cure-resin-applied intermediate disk structure. The two intermediate disk structures are rotated so that the UV cure resin is spread over the entire surface of each intermediate disk structure, thus both structures being stuck to each other.

The UV cure resin preferably includes epoxyacryrate, urethanacryrate, and the mixture of these materials as main ingredients.

As disclosed above, a dual-layer optical disk for one-side recording and reproduction is achieved with high reflectivity and also large modulation factor, and with no damage to the two recording layers.

The second recording 32 is provided with the second optically-transparent-resin thin-film protective layer 30 on one of its two surfaces in this embodiment. Not only that, it may be provided with two optically-transparent-resin thin-film protective layers 30 on both sides. Moreover, an optically-transparent dielectric layer may be provided instead of the first optically-transparent-resin thin-film protective layer 26.

Discussed next is evaluation of several sample optical disks that were produced in accordance with the embodiment of the optical disk according to the present invention disclosed above.

### SAMPLE 1

A first organic-dye recording layer 24 was formed on a first optically-transparent substrate 22, as follows:

Firstly, pre-grooves (groove width: 0. 3 μm, land width: 0. 44 μm) were formed on a 0. 6 mm-thick polycarbonate first optically-transparent substrate 22, at 0. 74-μm track pitch and 160-nm groove depth.

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 6-wt % solution.

The solution was applied on the pre-groove-formed first optically-transparent substrate 22. The substrate 22 was then rotated at 3000 rpm in spin coating. Thus, a 30 nm-thick first organic-dye recording layer 24 was formed.

Next, a first optically-transparent-resin thin-film protective layer 26 was formed on the first organic-dye recording layer 24, as follows:

A petroleum resin (Qinton1325® made by Zeon Co.) made of a copolyermer of cyclopentadiene and dicyclopentadiene, a thermoplastic resin exhibiting 125° C. in softening point, was dissolved in Cyclohexane (a nonpolar solution) to prepare a 6. 0-wt % solution.

The solution was applied on the first organic-dye recording layer 24. The substrate 22 was then rotated at 1000 rpm in spin coating, thus the first optically-transparent-resin thin-film protective layer 26 for protecting the first recording layer 24 was formed.

Accordingly, a sample-1 first intermediate disk structure M1 was produced with no damage to the first organic-dye recording layer 24.

Next, a metallic-film reflective layer 34 was formed on a second substrate 36, as follows:

Pre-grooves (groove width: 0. 3 μm, land width: 0. 44 μm) were formed on a 0. 6 mm-thick polycarbonate second substrate 36, at 0. 74-μm track pitch and 30-nm groove depth.

A metallic-film reflective layer 34 of 70 nm-thick Au film was formed by sputtering on the pre-groove-formed second substrate 36.

A second organic-dye recording layer 32 was then formed on the metallic-film reflective layer 34, as follows:

Cyanine (S06-DX001® made by Hayashibara Co. ltd.) exhibiting 585 nm in maximum absorption wavelength λmax (in dichloromethane solution) was dissolved in tetrafluoropropanol to prepare a 1. 0-wt % solution.

The solution was applied on the metallic-film reflective layer 34. The second substrate 36 was then rotated at 3000 rpm in spin coating, thus a 60 nm-thick second organic-dye recording layer 32 was formed.

Next, a second optically-transparent-resin thin-film protective layer 30 was formed on the second organic-dye recording layer 32, as follows:

A petroleum resin (Qinton1325® made by Zeon Co.) made of a copolyermer of cyclopentadiene and dicyclopentadiene, a thermoplastic resin exhibiting 125° C. in softening point, was dissolved in Cyclohexane (a nonpolar solution) to prepare a 6. 0-wt % solution.

One requirement for the thermoplastic resin to be used for the second optically-transparent-resin thin-film protective layer 30 is that it is softened and deformed at a particular temperature (the softening point) or lower at which the organic dye of the second recording layer 32 is decomposed when absorbing an irradiated laser beam in recording. This requirement is also applied to other samples disclosed later.

The solution was applied on the second organic-dye recording layer 32. The second substrate 36 was then rotated at 1000 rpm in spin coating, thus the second optically-transparent-resin thin-film protective layer 30 for protecting the second recording layer 32 was formed.

Accordingly, a sample-1 second intermediate disk structure M2 was produced with no damage to the second organic-dye recording layer 32.

As a transparent resin, a UV cure resin (modified urethane acryate, World Lock® No. 811 made by Kyoritu Chemical & Co. ltd.) was applied on the surface of the first optically-transparent-resin thin-film protective layer 26 of the sample-1 first intermediate disk structure M1.

The sample-1 second intermediate disk structure M2 was placed on the sample-1 first intermediate disk structure M1 so that the first and the second optically-transparent-resin thin-film protective layers 26 and 30 face each other.

The two sample-1 intermediate disk structures M1 and M2 were rotated at 2000 rpm while being irradiated with UV rays on the first optically-transparent substrate 22 side to harden the UV cure resin. An optically-transparent adhesive layer 28 was thus formed between the first and the second optically-transparent-resin thin-film protective layers 26 and 30.

A sample-1 dual-layer optical disk for one-side recording and reproduction was thus produced. The thickness of the optically-transparent adhesive layer 28 was 40 μm. No damage was found in the first and the second organic-dye recording layers 24 and 32 after bonded with the UV cure resin.

DVD-format signals were then recorded on the sample-1 optical disk, as produced above.

In detail, a semiconductor laser beam L having a wavelength of 660 nm was radiated onto the sample-1 optical disk on the first optically-transparent substrate 22 side. The laser beam L was focused on the second organic-dye recording layer 32 to record a DVD-format signal thereon. It was then focused on the first organic-dye recording layer 24 to record another DVD-format signal thereon. Recording was well performed on both of the first and the second recording layers 24 and 32.

Another semiconductor laser beam L having a wavelength of 660 nm was radiated onto the sample-1 optical disk on the first optically-transparent substrate 22 side for measuring reflectivity and reproducing the recorded DVD-format signals.

Firstly, the laser beam L was focused on the first organic-dye recording layer 24. The reflectivity was about 18%. Reproduction was well performed from the first recording layer 24. The laser beam L was then focused on the second organic-dye recording layer 32. The reflectivity was about 18%. Reproduction was also well performed from the second recording layer 32.

It was confirmed that recording and reproduction of DVD-format signals on and from the first and the second organic-dye recording layers 24 and 32 are possible with the reflectivity level within the standard specification of dual-layer DVD (so-called DVD dual layer). It was then also confirmed that this sample-1 optical disk is compatible with read-only dual-layer DVD in reflectivity.

### SAMPLE 1a

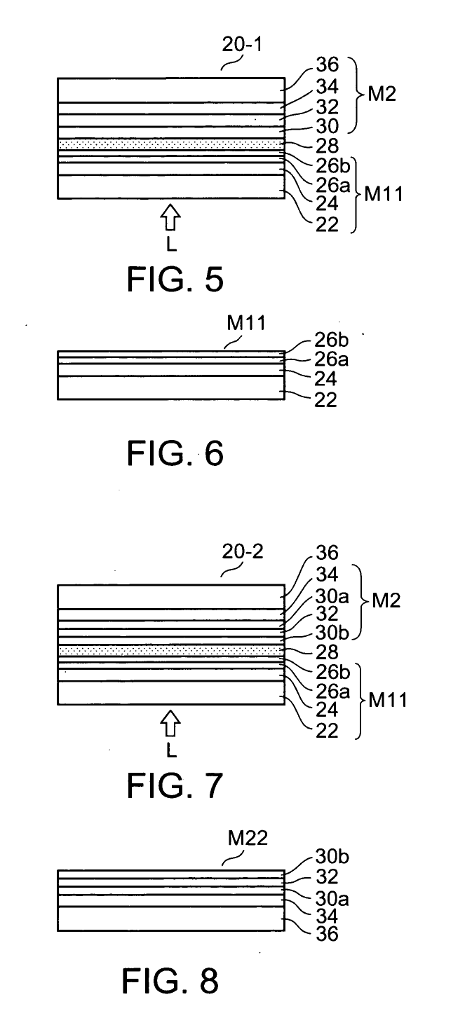

Next, a sample-1a optical disk 20-1 produced in accordance with the embodiment of the optical disk according to the present invention is disclosed with reference to FIGS. 5 and 6.

A first organic-dye recording layer 24 was formed on a first optically-transparent substrate 22, as follows:

Firstly, pre-grooves (groove width: 0. 3 μm, land width: 0. 44 μm) were formed on a 0. 6 mm-thick polycarbonate first optically-transparent substrate 22, at 0. 74-μm track pitch and 150-nm groove depth.

Cyanine (S06-DX001® made by Hayashibara Co. ltd.) exhibiting 585 nm in maximum absorption wavelength λmax (in dichloromethane solution) was dissolved in tetrafluoropropanol to prepare a 1. 0-wt % solution.

The solution was applied on the pre-groove-formed first optically-transparent substrate 22. The substrate 22 was then rotated at 1000 rpm in spin coating, thus an about-40 nm-thick first organic-dye recording layer 24 was formed.

Formed on the first organic-dye recording layer 24 by sputtering, different from the first optically-transparent-resin thin-film protective layer 26 in the sample 1, were a 15 nm-thick semi-transparent reflective layer 26a having an alloy of Ag as a main component and a 60 nm-thick optically-transparent dielectric layer 26b made of ZnS—SiO₂.

Accordingly, a sample-1a first intermediate disk structure M11 was produced as having the semi-transparent reflective layer 26a and the optically-transparent dielectric layer 26b, as shown in FIG. 6.

Next, a metallic-film reflective layer 34 was formed on a second substrate 36, as follows:

Pre-grooves (groove width: 0. 3 μm, land width: 0. 44 μm) were formed on a 0. 6 mm-thick polycarbonate second substrate 36, at 0. 74-μm track pitch and 120-nm groove depth.

A 100 nm-thick metallic-film reflective layer 34 having an alloy Ag as a main component was formed by sputtering on the pre-groove-formed second substrate 36.

A second organic-dye recording layer 32 was then formed on the metallic-film reflective layer 34, as follows:

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 75-wt % solution.

The solution was applied on the metallic-film reflective layer 34. The second substrate 36 was then rotated at 1000 rpm in spin coating, thus an about-35 nm-thick second organic-dye recording layer 32 was formed.

Next, a second optically-transparent-resin thin-film protective layer 30 was formed on the second organic-dye recording layer 32, as follows:

A petroleum resin (Zeonex480R® made by Zeon Co.) made of a copolyermer of cyclopentadiene and dicydopentadiene, a thermoplastic resin exhibiting 135° C. in softening point, was dissolved in Decalin (Decahydronaphthaene), a nonpolar solution, to prepare a 2. 0-wt % solution.

The solution was applied on the second organic-dye recording layer 32. The second substrate 36 was then rotated at 2500 rpm in spin coating, thus the second optically-transparent-resin thin-film protective layer 30 for protecting the second recording layer 32 was formed.

Accordingly, a sample-1a second intermediate disk structure M2 was produced with no damage to the second organic-dye recording layer 32.

As a transparent resin, a UV cure resin (modified urethane acryate, SD661® made by Dainippon Ink & Chemical Inc.) was applied on the surface of the optically-transparent dielectric layer 26b of the sample-1a first intermediate disk structure M1.

The sample-1a second intermediate disk structure M2 was placed on the sample-1a first intermediate disk structure M11 so that the optically-transparent dielectric layer 26b and the second optically-transparent-resin thin-film protective layer 30 face each other.

The two sample-1a intermediate disk structures M11 and M2 were rotated at 2000 rpm while being irradiated with UV rays on the first optically-transparent substrate 22 side to harden the UV cure resin. An optically-transparent adhesive layer 28 was thus formed between the optically-transparent dielectric layer 26b and the second optically-transparent-resin thin-film protective layer 30.

The sample-1a dual-layer optical disk 20-1 for one-side recording and reproduction was thus produced, as shown in FIG. 5. The thickness of the optically-transparent adhesive layer 28 was 45 μm. No damage was found in the first and the second organic-dye recording layers 24 and 32 after bonded with the UV cure resin.

DVD-format signals were then recorded on the sample-1a optical disk, as produced above.

In detail, a semiconductor laser beam L having a wavelength of 660 nm was radiated onto the sample-1a optical disk on the first optically-transparent substrate 22 side. The laser beam L was focused on the second organic-dye recording layer 32 to record a DVD-format signal thereon. It was then focused on the first organic-dye recording layer 24 to record another DVD-format signal thereon. Recording was well performed on both of the first and the second recording layers 24 and 32.

Another semiconductor laser beam L having a wavelength of 660 nm was radiated onto the sample-1a optical disk on the first optically-transparent substrate 22 side for measuring reflectivity and reproducing the recorded DVD-format signals.

Firstly, the laser beam L was focused on the first organic-dye recording layer 24. The reflectivity was about 20%. Reproduction was well performed from the first recording layer 24. The laser beam L was then focused on the second organic-dye recording layer 32. The reflectivity was about 18%. Reproduction was also well performed from the second recording layer 32.

It was confirmed that recording and reproduction of DVD-format signals on and from the first and the second organic-dye recording layers 24 and 32 are possible with the reflectivity level within the standard specification of dual-layer DVD (so-called DVD dual layer). It was then also confirmed that the sample-1a optical disk is compatible with read-only dual-layer DVD in reflectivity.

### SAMPLE 1b

Next, a sample-1b optical disk 20-2 produced in accordance with the embodiment of the optical disk according to the present invention is disclosed with reference to FIGS. 7 and 8.

A sample-1b first intermediate disk structure M11 was formed as identical with the sample-1a first intermediate disk structure M11.

A sample-1b second intermediate disk structure M22 was formed, as follows:

A metallic-film reflective layer 34 was formed on a second substrate 36.

Firstly, pre-grooves (groove width: 0. 3 μm, land width: 0. 44 μm) were formed on a 0. 6 mm-thick polycarbonate second substrate 36, 0. 74-μm track pitch and 150-nm groove depth.

A 100 nm-thick metallic-film reflective layer 34 having an alloy Ag as a main component was formed by sputtering on the pre-groove-formed second substrate 36.

Next, a second optically-transparent-resin thin-film protective layer 30a was formed on the metallic-film reflective layer 34, as follows:

A petroleum resin (Zeonex480R® made by Zeon Co.) made of a copolyermer of cyclopentadiene and dicyclopentadiene, a thermoplastic resin exhibiting 135° C. in softening point, was dissolved in Decalin (Decahydronaphthaene), a nonpolar solution, to prepare a 0. 2-wt % solution.

The solution was applied on the metallic-film reflective layer 34. The second substrate 36 was then rotated at 2500 rpm in spin coating, thus the second optically-transparent-resin thin-film protective layer 30a was formed.

A second organic-dye recording layer 32 was formed on the second optically-transparent-resin thin-film protective layer 30a, as follows:

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 75-wt % solution.

The solution was applied on the second optically-transparent-resin thin-film protective layer 30a. The second substrate 36 was then rotated at 1000 rpm in spin coating. Thus, an about-35 nm-thick second organic-dye recording layer 32 was formed.

Next, another second optically-transparent-resin thin-film protective layer 30b was formed on the second organic-dye recording layer 32, as follows:

A petroleum resin (Zeonex480R® made by Zeon Co.) made of a copolyermer of cyclopentadiene and dicyclopentadiene, a thermoplastic resin exhibiting 135° C. in softening point, was dissolved in Decalin (Decahydronaphthaene), a nonpolar solution, to prepare a 2. 0-wt % solution.

The solution was applied on the second organic-dye recording layer 32. The second substrate 36 was then rotated at 2500 rpm in spin coating, thus the second optically-transparent-resin thin-film protective layer 30b was formed.

Accordingly, the sample-1b second intermediate disk structure M22 was produced, as shown in FIG. 8.

The sample-1b second intermediate disk structure M22 is different from the sample-1a second intermediate disk structure M2 in that the second organic-dye recording layer 32 is sandwiched by the two second optically-transparent-resin thin-film protective layers 30a and 30b in the structure M22.

As a transparent resin, a UV cure resin (modified urethane acryate, ®SD661 made by Dainippon Ink & Chemical Inc.) was applied on the surface of the optically-transparent dielectric layer 26b of the sample-1b first intermediate disk structure M11.

The sample-1b second intermediate disk structure M22 was placed on the sample-1b first intermediate disk structure M11 so that the optically-transparent dielectric layer 26b and the second optically-transparent-resin thin-film protective layer 30b faced each other.

The two sample-1b intermediate disk structures M11 and M22 were rotated at 2000 rpm while being irradiated with UV rays on the first optically-transparent substrate 22 side to harden the UV cure resin. An optically-transparent adhesive layer 28 was thus formed between the optically-transparent dielectric layer 26b and the second optically-transparent-resin thin-film protective layer 30b.

The sample-1b dual-layer optical disk 20-2 for one-side recording and reproduction was thus produced, as shown in FIG. 7. The thickness of the optically-transparent adhesive layer 28 was 45 μm. No damage was found in the first and the second organic-dye recording layers 24 and 32 after bonded with the UV cure resin.

DVD-format signals were then recorded on the sample-1b optical disk, as produced above.

In detail, a semiconductor laser beam L having a wavelength of 660 nm was radiated onto the sample-1b optical disk on the first optically-transparent substrate 22 side. The laser beam L was focused on the second organic-dye recording layer 32 to record a DVD-format signal thereon. Recording was well performed on the second recording layer 32 with a lower recording power than that for the sample-1a optical disk. The laser beam L was then focused on the first organic-dye recording layer 24 to record another DVD-format signal thereon.

Recording was well performed on the first recording layer 24.

Another semiconductor laser beam L having a wavelength of 660 nm was radiated onto the sample-1b optical disk on the first optically-transparent substrate 22 side for measuring reflectivity and reproducing the recorded DVD-format signals.

Firstly, the laser beam L was focused on the first organic-dye recording layer 24. The reflectivity was about 20%. Reproduction was well performed from the first recording layer 24. The laser beam L was then focused on the second organic-dye recording layer 32. The reflectivity was about 20%. Reproduction was also well performed from the second recording layer 32.

It was confirmed that recording and reproduction of DVD-format signals on and from the first and the second organic-dye recording layers 24 and 32 are possible with the reflectivity level within the standard specification of dual-layer DVD (so-called DVD dual layer). It was then also confirmed that the sample-1b optical disk is compatible with read-only dual-layer DVD in reflectivity.

### COMPARATIVE SAMPLE 1

For comparison with the samples of the present invention, a comparative sample was produced in that one of two organic-dye recording layers was sandwiched by two transparent thin-film layers made of a hard inorganic compound.

A comparative-sample first intermediate disk structure Mc1 was formed as identical with the sample-1a first intermediate disk structure M1.

A comparative-sample second intermediate disk structure Mc2 was formed, as follows:

A metallic-film reflective layer 34 was formed on a second substrate 36.

Firstly, pre-grooves (groove width: 0. 3 μm, land width: 0. 44 μm) were formed on a 0. 6 mm-thick polycarbonate second substrate 36, at 0. 74-μm track pitch and 30-nm groove depth.

A 100nm-thick metallic-film reflective layer 34 having an alloy Ag 5 as a main component was formed by sputtering on the pre-groove-formed second substrate 36.

Formed on the metallic-film reflective layer 34 by sputtering was a 10-nm-thick SiN-made optically-transparent inorganic thin-film layer.

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 75-wt % solution.

The solution was applied on the optically-transparent inorganic thin-film layer. The second substrate 36 was then rotated at 1000 rpm in spin coating, thus an about-30 nm-thick second organic-dye recording layer 32 was formed.

Formed on the second organic-dye recording layer 32 by sputtering was a 40-nm-thick SiN-made optically-transparent inorganic thin-film layer.

Accordingly, the comparative-sample second intermediate disk structure Mc2 was produced.

The comparative-sample second intermediate disk structure Mc2 is different from the sample-1b second intermediate disk structure M2 in that the second organic-dye recording layer 32 is sandwiched by two SiN-made transparent inorganic thin-film layers in the comparative sample 1.

As a transparent resin, a UV cure resin (modified urethane acryate, ®SD661 made by Dainippon Ink & Chemical Inc.) was applied on the surface of the optically-transparent dielectric layer of the comparative-sample first intermediate disk structure Mc1.

The comparative-sample second intermediate disk structure Mc2 was placed on the comparative-sample first intermediate disk structure Mc1 so that the optically-transparent dielectric layer and one of the two transparent inorganic thin-film layers faced each other.

The two comparative-sample intermediate disk structures Mc1 and Mc2 were rotated at 2000 rpm while being irradiated with UV rays on the first optically-transparent substrate 22 side to harden the UV cure resin. An optically-transparent adhesive layer 28 was thus formed between the optically-transparent dielectric layer and the transparent inorganic thin-film layer.

A comparative-sample dual-layer optical disk for one-side recording and reproduction was thus produced. The thickness of the optically-transparent adhesive layer 28 was 45 μm. No damage was found in the first and the second organic-dye recording layers 24 and 32 after bonded with the UV cure resin.

A semiconductor laser beam L having a wavelength of 660 nm was radiated onto the comparative sample 1 on the first optically-transparent substrate 22 side. The laser beam L was focused on the second organic-dye recording layer 32 to record a DVD-format signal thereon.

An open eye pattern was not obtained even though recording power was raised, and thus recording was failed. It is confirmed that recording failure occurs in a sandwich structure in which an organic-dye recording layer is sandwiched by two transparent thin-film layers made of an inorganic material exhibiting high thermal conductivity and being unprone to softening different from a thermoplastic resin.

### SAMPLE 2

Most write-once dual-layer optical disks for one-side recording and reproduction requires two recording layers made of an organic dye, such as, cyanine, phthalocyanine or azoic dye.

When a recording layer made of an organic dye is irradiated with a laser beam, the organic dye absorbs it and suffers thermal decomposition, which causes substrate deformation, etc., thus recorded marks were formed on the recording layer.

A recording layer requires adjustments to spectral characteristics of its material for absorbing light of specific wavelength. Organic dyes exhibit spectral characteristics depending on their molecular structures. In other words, organic dyes exhibit the same spectral characteristics when their molecular structures are identical to one other.

Typical dual-layer optical disks have optically-transparent intermediate layers between a first recording layer L0 and a second recording layer L1.

The first recording layer L0 is defined as a recording layer provided as close to the laser-incident side whereas the second recording layer L1 is defined as a recording layer provided as apart from the laser-incident side, in a dual-layer optical disk for one-side recording and reproduction.

The terms, the first and the second recording layers L0 and L1, as defined above, sometimes appear in the disclosure below.

Existence of such optically-transparent intermediate layers causes difference in optical path length to the two recording layers L0 and L1. In other words, the recording layers L0 and L1, with the intermediate layers, exhibit different spectral characteristics due to existence of such intermediate layers.

The spectral characteristics of a material of a recording layer is decided for a normal type of DVD-R so that optimum recording and reproduction can be performed with laser beams through a 0. 6 mm-thick transparent substrate.

The second recording layer L1, however, exhibits spectral characteristics different from that of the first recording layer L0, when they were made of the same material, due to existence of the intermediate layers, as discussed above. This causes unacceptable recording and reproduction characteristics for dual-layer optical disks.

The sample-1, -1a and -1b optical disks according to the present invention, however, overcame such problems with the structures, as disclosed above.

Different from the samples 1, 1a and 1b, the sample 2 of the present invention uses materials of different molecular structures for two recording layers L0 and L1 to achieve optimum spectral characteristics against laser wavelength for each recording layer in recording and reproduction.

The optical-disk recording and reproduction characteristics strongly relate to spectral characteristics such as absorbance and reflectivity of a recording layer against laser wavelength.

The spectral characteristics of dyes used for write-once optical disks in the visible-light range depends on the length of conjugated double-bond structures in a molecule and the type of functional groups of side chains in the structures. This teaches that change in molecular structures offers better recording and reproduction characteristics.

In the sample 2, molecular structures of materials to be used for first and the second recording layers 24 and 32 (FIG. 2) are adjusted as different from each other so that the two recording layers can exhibit optimum recording and reproduction characteristics.

A longer optical path length to an object to be examined, with a thin-film layer made of a transparent material exhibiting a refractive index different from that of atmosphere between an optical source and the object, tends to provide a particular spectral characteristics in which a spectral curve is shifted on wavelength (the axis of abscissas).

This teaches that the material for the first recording layer L0 that gives optimum recording and reproduction characteristics to this recording layer may not always offer the same optimum characteristics to the second recording layer L1 when the same material is used for the latter recording layer in typical dual-layer optical disks for one-side recording and reproduction.

In other words, the material for the second recording layer L1 must be selected so that it gives optimum recording and reproduction characteristics to this recording layer against laser wavelength in recording and reproduction via the first recording layer L0 and intermediate layers.

These materials for the first and the second recording layers L0 and L1 exhibit different inherent spectral characteristics.

Such material for the first recording layer 24 (FIG. 2) in the sample 2 is, for example, made by coating the recording layer with a 0. 7-wt % solution of tetrafluoropropanol, dissolved in which is cyanine (S06-DX001® made by Hayashibara Co. ltd.) exhibiting 585 nm in maximum absorption wavelength λmax (in dichloromethane solution).

In contrast, such material for the second recording layer 32 (FIG. 2) in the sample 2 is, for example, made by coating the recording layer with a 0. 7-wt % solution of tetrafluoropropanol, dissolved in which is cyanine exhibiting 538 nm in maximum absorption wavelength λmax (in dichloromethane solution).

Discussed next is evaluation of the sample 2 of the embodiment according to the present invention and a comparative sample 2 produced as explained below.

### COMPARATIVE SAMPLE 2

A first organic-dye recording layer 24 was formed on a first optically-transparent substrate 22.

Firstly, pre-grooves (groove width: 0. 3 μm, land width: 0. 44 μm) were formed on a 0. 6 mm-thick polycarbonate first optically-transparent substrate 22 (120 mm in diameter), at 0. 74-μm track pitch and 150-nm groove depth.

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 7-wt % solution.

The solution was applied on the pre-groove-formed first optically-transparent substrate 22. The substrate 22 was then rotated at 1000 rpm in spin coating, thus a 40 nm-thick first organic-dye recording layer 24 was formed.

Formed on the first organic-dye recording layer 24 in the comparative sample 2 was a 100 nm-thick reflective layer 50 by sputtering with a target of an alloy of Ag as a main component. Such reflective layer 50 was not formed for the sample 2 of the present invention as disclosed later.

Further formed on the reflective layer 50 was a 15 μm-thick first optically-transparent-resin thin-film layer 26 with spin coating of a UV-cure epoxy resin and radiation of UV rays to harden the resin.

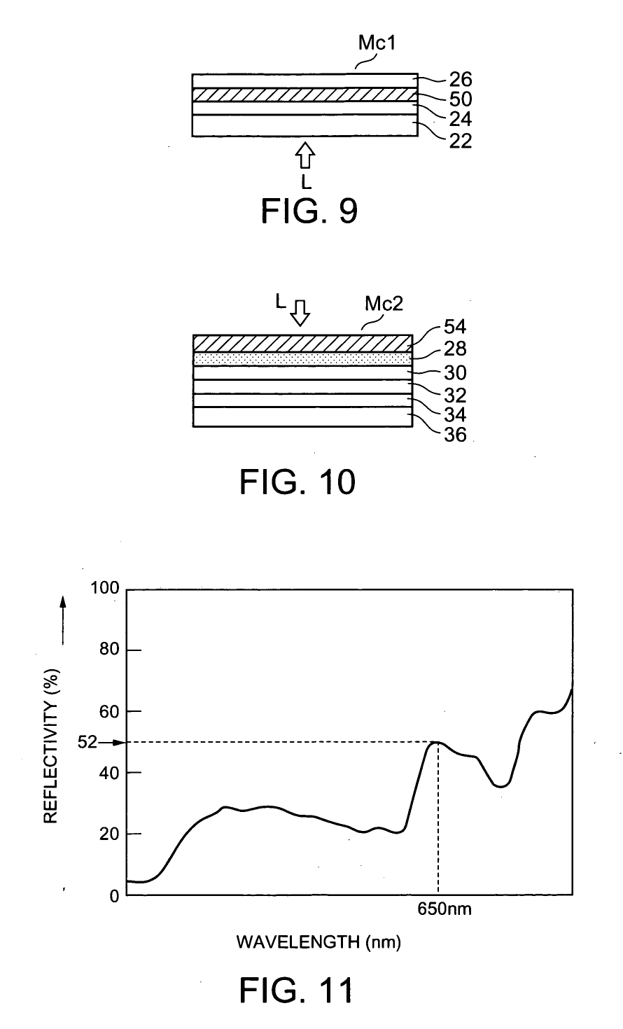

Accordingly, a first intermediate disk structure Mc1 (comparative sample 2) was produced as shown in FIG. 9. This structure Mc1 had a similar structure to the first intermediate disk structure M1 shown in FIGS. 2 and 3, except that the structure Mc1 had the reflective layer 50 for evaluation of reflectivity under the same condition with a second intermediate disk structure Mc1 (comparative sample 2) produced as explained below.

Next, a 100 nm-thick reflective layer 34 was formed on a second substrate 36, identical to the first optically-transparent substrate 22 of the first intermediate disk structure Mc1 (comparative sample 2) in size and material, by sputtering with a target of an alloy of Ag as a main component.

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 7-wt % solution.

The solution was applied on the reflective layer 34. The second substrate 36 was then rotated at 1000 rpm in spin coating, thus an about-40 nm-thick second organic-dye recording layer 32 was formed. The material for the second recording layer 32 was identical to that for the first recording layer 24 of the first intermediate disk structure Mc1 (comparative sample 2).

Next, a second optically-transparent-resin thin-film protective layer 30 was formed on the second organic-dye recording layer 32, as follows:

A petroleum resin (Quintone1325® made by Zeon Co.) made of a copolyermer of cyclopentadiene and dicyclopentadiene, a thermoplastic resin exhibiting 125° C. in softening point, was dissolved in cyclohexane, a nonpolar solution, to prepare a 6. 0-wt % solution.

The solution was applied on the second organic-dye recording layer 32. The second substrate 36 was then rotated at 2500 rpm in spin coating, thus the second optically-transparent-resin thin-film layer 30 for protecting the second recording layer 32 was formed.

A polycarbonate second optically-transparent substrate 54 (having 0. 6 mm in thickness and 120 mm in diameter) was then stuck onto the second optically-transparent-resin thin-film layer 30 via a 50 μm-thick optically-transparent adhesive layer 28 using a sheet adhesive (made by Nitto Denko).

Accordingly, the second intermediate disk structure Mc2 (comparative sample 2) was produced, as shown in FIG. 10, with no damage to the second recording layer 32. This structure Mc2 had a similar structure to the second intermediate disk structure M2 shown in FIGS. 2 and 4, except that the structure Mc2 had the second optically-transparent substrate 54 via the optically-transparent adhesive layer 28 for evaluation of spectral characteristics.

Spectral characteristics of the first and the second intermediate disk structures Mc1 and Mc2 (comparative sample 2) were measured by a spectrophotometer (UV-3101PC, made by Shimadzu Co.).

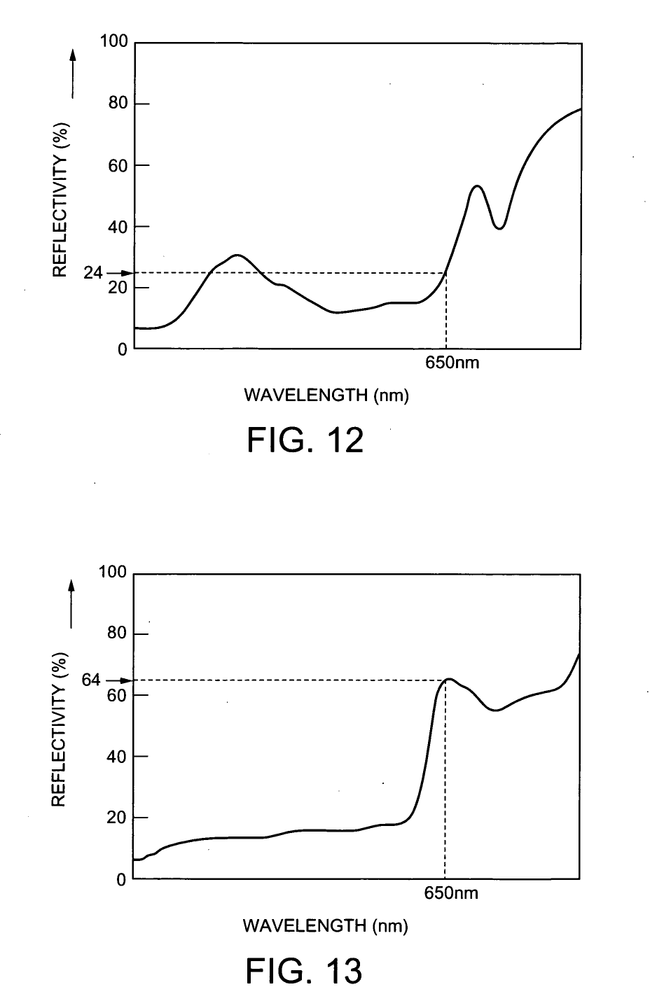

The measured spectral characteristics are shown in FIGS. 11 and 12 for the first and the second intermediate disk structures Mc1 and Mc2 (comparative sample 2), respectively.

FIGS. 11 and 12 show a big difference in spectral characteristics between the first and the second intermediate disk structures Mc1 and Mc2 (comparative sample 2) when the same material was used for the first and the second recording layers 24 and 32.

In detail, reflectivity shows a big difference between the first and the second intermediate disk structures Mc1 and Mc2 (comparative sample 2) at 650 nm (and its vicinity) in DVD-R standard. Reflectivity is about 52% at 650 nm (and its vicinity) for the first structure Mc1, as shown in FIG. 11. In contrast, it is about 24% at 650 nm (and its vicinity) for the second structure Mc2, as shown in FIG. 12.

Recording and reproduction characteristics were evaluated for the first and the second intermediate disk structures Mc1 and Mc2 (comparative sample 2) with a DVD-R evaluator at 650 nm in laser wavelength and 0. 65 in lens NA (Numerical Aperture).

It was revealed that the second intermediate disk structure Mc2 was much inferior to the first intermediate disk structure Mc1 in recording and reproduction characteristics.

In particular, the second intermediate disk structure Mc2 exhibited a modulation factor of about 30% almost ½ of that of the first intermediate disk structure Mc1, possibly due to extremely low initial reflectivity of the disk S2.

Moreover, reflectivity measured with the same DVD-R evaluator was about 55% for the first intermediate disk structure Mc1, whereas it was about 10% for the second intermediate disk structure Mc2, extremely unacceptable level.

### PRODUCTION OF SAMPLE 2

A sample-2 second intermediate disk structure M2 was produced in the same way as for the second intermediate disk structure Mc2 (comparative sample 2) except that a second recording layer 32, such as shown in FIGS. 2 and 4, in the sample 2 included a dye having a particular molecular structure which was obtained as disclosed below.

The maximum absorption wavelength λmax (in the visible range) of a dye to be used for such a second recording layer 32 can be relatively easily adjusted by modifying a molecular structure of the dye.

The number of carbons in methine chains, the basic structure of dyes in the family of cyanine, increases for cyanine (monomethine cyanine), carbocyanine (trimethine cyanine), dicarbocyanine (pentamethine cyanine), and tricarbocyanine (heptamethine cyanine), in this order.

The maximum absorption wavelength λmax is shifted into a longer wavelength range as the number of carbons in methine chains of a dye in the family of cyanine increases, as stated above, when such dye is used for a recording layer.

The number of carbons in methine chains is different among dyes in the family of cyanine and the maximum absorption wavelength λmax is shifted into a longer wavelength range as the number of those carbons increases, as discussed above.

In other words, a dye to be used for a recording layer can be selected from the family of cyanine in accordance with a laser wavelength in recording. Carbocyanine (trimethine cyanine) and dicarbocyanine (pentamethine cyanine) are suitable dyes in the family of cyanine that exhibit 650 nm in the maximum absorption wavelength λmax in recording when used for DVD-R recording layers.

Difference of 1 in the number “n” of methine chains gives variation in absorption wavelength in the range from several ten to several hundred nanometers.

A desired maximum absorption wavelength λmax can be given by selecting a functional group attached to each methine chain, the basic structure of dyes in the cyanine family.

In other words, selection among functional groups attached to methine chains (having the same carbon number) of dyes in the cyanine family enables fine adjustments to the maximum absorption wavelength λmax in the range from several nanometers to several ten nanometers.

For example, 1, 3, 3, 1′, 3′, 3′-hexamethyl- 2, 2′-indocarbocyanine iodide has the structure identical to 1, 3, 3, 1′, 3′, 3′-hexamethyl-2, 2′-(4, 5, 4′, 5′-dibenzo)-indocarbocyanine iodide, except that the former structure lacks two benzene rings.

The former structure exhibits 545 nm whereas the latter structure 586 nm in the maximum absorption wavelength λmax in a methanol solution.

In other words, the maximum absorption wavelength λmax of the latter structure is shifted by about 40 nm to a shorter wavelength range, without having the two benzene rings.

Moreover, 3, 3′, 9-triethyl-9-2, 2′-(6, 7, 6′, 7′- dibenzo)-thiacarbocyanine iodide has the structure identical to 3, 3′-diethyl- 2, 2′-(6, 7, 6′, 7′-dibenzo)-thiacarbocyanine iodide, except that the former structure has the ethyl group as a substituent in the cyanine structure.

The former structure exhibits 578 nm whereas the latter structure 593 nm in the maximum absorption wavelength λmax in a methanol solution.

In other words, the maximum absorption wavelength λmax of the latter structure is shifted by about 15 nm to a shorter wavelength range, with the ethyl group as a substituent in the cyanine structure.

Likewise, 3, 3′,-diethyl-9-methyl-2, 2′-(6, 7, 6′, 7′-dibenzo)-thiacarbocyanine iodide has the structure identical to the above latter structure, except that the former structure has the ethyl group as a substituent in the cyanine structure.

The former structure exhibits 572 nm in the maximum absorption wavelength λmax in a methanol solution.

In other words, the maximum absorption wavelength λmax of the latter structure is shifted by about 15 nm to a shorter wavelength range, with the ethyl group as a substituent in the cyanine structure.

Moreover, substituent groups having an electron drawing effect under a basic molecular structure the same as that of cyanine (S06-DX001® made by Hayashibara Co. ltd.) can shift the maximum absorption wavelength λmax to a longer wavelength range.

As disclosed above, selection of substituents in structure and type enables adjustments to the maximum absorption wavelength λmax to a shorter or a longer wavelength range.

FIG. 13 shows spectral characteristics of the sample-2 second intermediate disk structure M2 having the second recording layer 32 made of material different from a first recording layer 24 of a sample-2 first intermediate disk structure M1 which will be disclosed later.

Reflectivity was raised to about 64% at 650 nm (and its vicinity) from that of the second intermediate disk structure Mc2 of the comparative sample 2 shown in FIG. 12.

Evaluation of recording and reproduction characteristics of the sample-2 second intermediate disk structure M2 with the DVD-R evaluator at 650 nm in laser wavelength and 0. 65 in lens NA showed about 60% in reflectivity, an acceptable improvement.

Next, the sample-2 first intermediate disk structure M1 having a first recording layer 24, such as shown in FIGS. 2 and 3, was produced, without such reflective layer 50 of the comparative sample 2 shown in FIG. 9, for higher transmissivity.

The first organic-dye recording layer 24 was formed on a first optically-transparent substrate 22, as follows:

Firstly, pre-grooves (groove width: 0. 3 μm, land width: 0. 44 μm) were formed on a 0. 6 mm-thick polycarbonate first optically-transparent substrate 22, at 0. 74-μm track pitch and 150-nm groove depth.

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 8-wt % solution.

The solution was applied on the pre-groove-formed first optically-transparent substrate 22. The substrate 22 was then rotated at 1000 rpm in spin coating, thus a 50 nm-thick first organic-dye recording layer 24 was formed.

Next, a first optically-transparent-resin thin-film protective layer 26 was formed on the first organic-dye recording layer 24, as follows:

A petroleum resin (Qinton1325® made by Zeon Co.) made of a copolyermer of cyclopentadiene and dicyclopentadiene, a thermoplastic resin exhibiting 125° C. in softening point, was dissolved in Cyclohexane (a nonpolar solution) to prepare a 7. 0-wt % solution.

The solution was applied on the first organic-dye recording layer 24. The substrate 22 was then rotated at 2500 rpm in spin coating, thus the first optically-transparent-resin thin-film protective layer 26 for protecting the first recording layer 24 was formed.

Accordingly, a sample-2 first intermediate disk structure M1 having the first recording layer 24 was produced.

The sample-2 first intermediate disk structure M1 having the first recording layer 24 and the sample-2 second intermediate disk structure M2 having the second recording layer 32 were stuck to each other via a 50 μm-thick optically-transparent adhesive layer 28 using a sheet adhesive (made by Nitto Denko). Thus, a sample-2 dual-layer optical disk such as shown in FIG. 2 was produced.

Recording and reproduction characteristics were evaluated for the sample-2 first and second intermediate disk structures M1 and M2 with a DVD-R evaluator at 650 nm in laser wavelength and 0. 65 in lens NA (Numerical Aperture).

The evaluation results were as follows: 55 dB in C/N (Noise carrying Ratio) and 68% in modulation factor for the first recording layer 24; 50 dB in C/N and 60% in modulation factor for the second recording layer 32; and about 18% in reflectivity against 650 nm-wavelength laser for both recording layers. This reflectivity lies within the standard specification of read-only dual-layer DVD (so-called DVD dual layer). It was then confirmed that the sample-2 optical disk is compatible with read-only dual-layer DVD in reflectivity.

Adjustments to Difference in Optical Path Length Between Groove and Land in Guide Groove

Write-once optical disks having organic-dye recording layers achieve optimum optical phase with adjustments to the depth of substrate guide grooves and the thickness of recording layers, etc., for higher reflectivity.

Such adjustments are made based on recording and reproduction mechanisms for those optical disks in that: a laser beam is reflected mainly from the interface between a transparent layer such as a substrate and a recording layer and also from the interface between a recording layer and a reflective layer; and a phase difference occurs between a laser beam reflected from each concave groove and that from each convex land having a specific distance therebetween on a guide groove.

Organic-dye recording layers for write-once optical disks are usually formed with spin coating of the material of recording layers dissolved in an organic solvent. The depth of a guide groove on a DVD substrate is usually 100 nm or deeper with respect to laser wavelength in recording and reproduction. The film formed with spin coating in such a depth is thicker on concave grooves than convex lands due to surface tension.

A metallic reflective layer is then formed on a recording layer formed as disclosed above. Such a metallic reflective layer is usually formed by a vacuum dry process, sputtering, for example. Sputtering gives almost the same film thickness to grooves and lands according to the sputtering film-forming mechanism.

As already disclosed with reference to FIG. 2, in case of the dual-layer optical disk according to the present invention, the metallic-film reflective layer 34 is firstly formed on the second substrate 36 and then the second recording layer 32 is formed on the reflective layer 34.

The second recording layer 32 exhibits difference in film thickness in that the film thickness of inverted (convex) grooves is thinner than that of concave lands when formed by spin coating in the same way as for ordinary write-once optical disks.

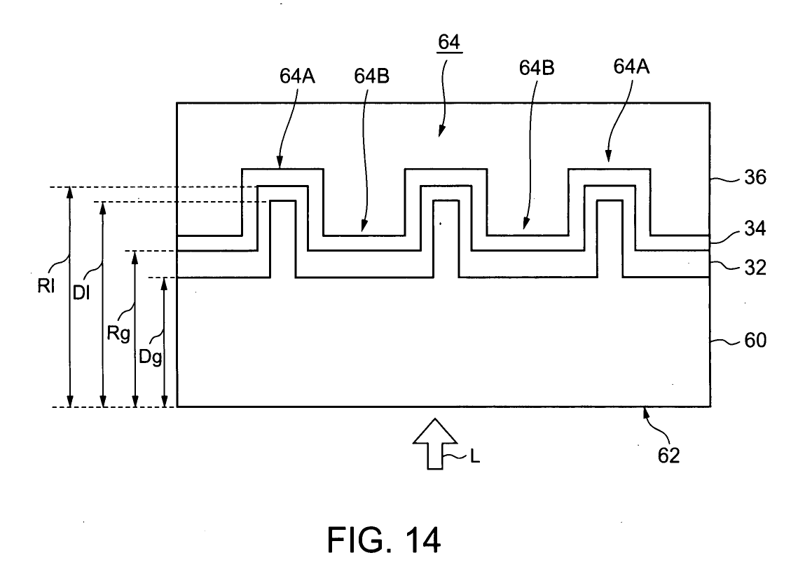

It is noted that concave and convex shapes of grooves and lands of the guide groove of the second recording layer 32 are reversed or inverted. This is because that the light-incident plane is the surface of the first optically-transparent substrate 22 (the bottom surface in FIG. 2) opposed to the second substrate 36 in the dual-layer optical disk of the present invention, which will be explained later with reference to FIG. 14.

A laser-beam spot is focused down to a diameter of about 1 μm via an objective lens installed in a pickup in recording or reproduction for DVD. In contrast, a spiral guide groove on DVD has 0. 74 μm in track pitch according to the standard specification. The beam spot is focused on both of a land and a groove as if it straddles them in recording or reproduction, thus phase difference between beams reflected from the land and the groove significantly affects reflectivity.

Discussed next is the thickness of each layer, the depth of a guide groove, and the distance from the light-incident plane to the interface of each layer.

Illustrated in FIG. 14 is an enlarged cross section of an upper-half disk (such as shown in FIGS. 2 and 4) including a second recording layer L1 that is apart from the light-incident plane, in the dual-layer optical disk according to the present invention.

Laminated in order on a second substrate 36 are a reflective layer 34, a second recording layer 32, and an optically-transparent layer 60 having a light-incident plane 62 in which a laser beam L is incident in recording or reproduction.

The optically-transparent layer 60 is optically equivalent to the first intermediate disk structure M1 having the first optically-transparent substrate 22 shown in FIG. 3.

Formed on the surface of the second substrate 36 (on the 10 reflective layer 34 side) is a concave and convex guide groove 64 having concave lands 64A and inverted grooves 64B (convex in the downward direction in FIG. 14) with respect to the light-incident plane 62, the bottom surface in FIG. 14.

Reference signs D1, Dg, R1 and Rg shown in FIG. 14 indicate the following definitions:

D1: the distance from the light-incident plane 62 to the interface of the second recording layer 32 on the lands 64A;

Dg: the distance from the light-incident plane 62 to the interface of the second recording layer 32 on the grooves 64B;

R1: the distance from the light-incident plane 62 to the interface of the reflective layer 34 (the interface between the layer 34 and the second recording layer 32) on the lands 64A; and

Rg: the distance from the light-incident plane 62 to the interface of the reflective layer 34 (the interface between the layer 34 and the second recording layer 32) on the groove 64B

Reflected lights from the lands and grooves on each interface affect one another, thus significantly affecting optical phase. This can be indicated by an index that is the optical-path distance to the lands and grooves on each interface, which is expressed as follows:

Optical-path distance from the optically-transparent layer to the interface of the second recording layer L1: D1−Dg;

Optical-path distance from the second recording layer L1 to the interface of the reflective layer: R1−Rg

It is found that the relational expression D1−Dg≧R1−Rg must be satisfied for achieving high reflectivity of 50% or higher in write-once optical disks having a single recording layer.

The above relational expression means that the film thickness of the second recording layer 32 on the grooves 64B must be thicker than that of the same recording layer on the lands 64A (Rg−Dg≧R1−D1) for achieving such high reflectivity.

The dual-layer write-once optical disk according to the present invention requires reflectivity in the range from about 18% to 30% for each recording layer (after bonded), in other words, 50% or higher for the second recording layer 32 (before bonded), to meet compatibility with read-only optical disks (ROM).

In a bonding process, the reflective layer 34 must be formed on the second substrate 36 before the second organic-dye recording layer 32 was formed, as disclosed above. Mere spin coating of the second recording layer 32 like in known optical disks gives the unacceptable relational expression D1−Dg<R1−Rg.

Such unacceptable relational expression gives reflectivity of about 30% only no matter how the depth of the guide groove 64 on the second recording layer 32 is adjusted.

A unique film-forming method according to the present invention for the second recording layer 32 satisfies the relational expression D1−Dg≧R1−Rg to achieve high reflectivity.

In detail, the relational expression D1−Dg≧R1−Rg is written as Rg−Dg≧R1−D1. This relational expression means that the film thickness of the second recording layer 32 on the grooves 64B must be thicker than that of the same recording layer on the lands 64A for achieving high reflectivity, as discussed above.

Such relational expression can be given, for example, by vacuum deposition, as discussed later.

Discussed below is evaluation of sample optical disks according to the present invention produced in accordance with the above relational expression.

### SAMPLE 3

A first organic-dye recording layer 24 was formed on a first optically-transparent substrate 22, as follows:

Firstly, pre-grooves (groove width: 0. 3 μm, land width: 0. 44 μm) were formed on a 0. 6 mm-thick polycarbonate first optically-transparent substrate 22 (120 mm in diameter), at 0. 74-μm track pitch and 160-nm groove depth.

Cyanine (S06-DX001® made by Hayashibara Co. ltd.) exhibiting 585 nm in maximum absorption wavelength λmax (in dichloromethane solution) was dissolved in tetrafluoropropanol to prepare a 0. 75-wt % solution.

The solution was applied on the pre-groove-formed first optically-transparent substrate 22. The substrate 22 was then rotated at 1000 rpm in spin coating, thus a first organic-dye recording layer 24 having 25 nm-thick lands and 60 nm-thick grooves were formed.

Formed on the first organic-dye recording layer 24 in the sample 3 was a 15 nm-thick reflective layer 50 by sputtering with a target of an alloy of Ag as a main component.

Further formed on the reflective layer 50 was a 15 μm-thick first optically-transparent-resin thin-film layer 26 with spin coating of a UV-cure epoxy resin and radiation of UV rays to harden the resin.

Accordingly, a sample-3 first intermediate disk structure M1 was produced, such as shown in FIG. 3, but with the reflective layer 50.

Next, a 150 nm-thick reflective layer 34 was formed on a second substrate 36 produced in the same way as the first optically-transparent 20 substrate 22 of the sample-3 first intermediate disk structure M1, by sputtering with a target of an alloy of Ag as a main component.

Formed on the reflective layer 34 was a second organic-dye recording layer 32 by vacuum deposition (not spin coating) with phthalocyanine exhibiting 565 nm in maximum absorption wavelength λmax (in dichloromethane solution).

The second recording layer 32 formed as above had a film thicknesses of 50 nm on lands 64A and 60 nm on grooves 64B. These film thicknesses give Rg−Dg=60 nm and R1−D1=50 nm. In other words, the film thickness of grooves 64B is thicker than that of lands 30 64A, which satisfies the relational expression Rg−Dg≧R1−D1.

A petroleum resin (Qinton1325 made by Zeon Co.) made of a copolyermer of cyclopentadiene and dicyclopentadiene, a thermoplastic resin exhibiting 125° C. in softening point, was dissolved in Cyclohexane (a nonpolar solution) to prepare a 6. 0-wt % solution.

The solution was applied on the second recording layer 32. The substrate 36 was then rotated at 2500 rpm in spin coating, thus the second optically-transparent thermoplastic-resin thin-film layer 30 for protecting the second recording layer 32 was formed.

A polycarbonate second optically-transparent substrate 54 (having 0. 6 mm in thickness and 120 mm in diameter) was then stuck onto the second optically-transparent-resin thin-film layer 30 via a 50 μm-thick optically-transparent adhesive layer 28 using a sheet adhesive (made by Nitto Denko).

Accordingly, a sample-3 second intermediate disk structure M2 was produced with no damage to the second recording layer 32, such as shown in FIG. 4, but with the second optically-transparent substrate 54 via the optically-transparent adhesive layer 28.

The optically-transparent substrate 54 and the optically-transparent adhesive layer 28 correspond to the optically-transparent layer 60 shown in FIG. 14.

Reflectivity was evaluated for each of the sample-3 first and second intermediate disk structures M1 and M2 with a DVD evaluator (DDU-1000 made by Pulse Tech Co.).

The sample-3 first intermediate disk structure M1 exhibited 18% in reflectivity. In contrast, the sample-3 second intermediate disk structure M2 exhibited 58% in reflectivity. It was well beyond 50%, showing a preferable result.

The sample-3 first and second intermediate disk structures M1 and M2 were stuck to each other via a 50 μm-thick optically-transparent adhesive layer 28 using a sheet adhesive (made by Nitto Denko), thus a sample-3 dual-layer optical disk was produced.

Recording and reproduction characteristics were evaluated for the sample-3 optical disk with a DVD-R evaluator at 658 nm in laser wavelength and 0. 65 in lens NA.

The sample-3 second intermediate disk structure M2 exhibited 20% in reflectivity, practically enough for a storage medium.

The further evaluation results were as follows: 55 dB in C/N and 68% in modulation factor for the first recording layer 24; 50 dB in C/N and 60% in modulation factor for the second recording layer 32; and 18% and higher in reflectivity against 650 nm-wavelength laser for both recording layers. This reflectivity lies within the standard specification of read-only dual-layer DVD (so-called DVD dual layer). It was then confirmed that the sample-3 optical disk is compatible with read-only dual-layer DVD in reflectivity.

### SAMPLE 4

A 150 nm-thick reflective layer 34 was formed on a second substrate 36 produced in the same way as the counterpart 36 of the sample 3 by sputtering with a target of an alloy of Ag as a main component.

Formed on the reflective layer 34 was a second organic-dye recording layer 32 by vacuum deposition (not spin coating) with phthalocyanine exhibiting 565 nm in maximum absorption wavelength λmax (in dichloromethane solution).

The second recording layer 32 formed as above had a film thicknesses of 70 nm on lands 64A and also on grooves. These film thicknesses give Rg−Dg=70 nm and R1−D1=70 nm. In other words, the film thickness of grooves 64B is equal to that of lands 64A, which satisfies the relational expression Rg−Dg≧R1−D1.

A petroleum resin (Qinton1325® made by Zeon Co.) made of a copolyermer of cyclopentadiene and dicyclopentadiene, a thermoplastic resin exhibiting 125° C. in softening point, was dissolved in Cyclohexane (a nonpolar solution) to prepare a 6. 0-wt % solution.

The solution was applied on the second recording layer 32. The substrate 36 was then rotated at 2500 rpm in spin coating, thus the second optically-transparent thermoplastic-resin thin-film layer 30 for protecting the second recording layer 32 was formed.

A polycarbonate second optically-transparent substrate 54 (having 0. 6 mm in thickness and 120 mm in diameter) was then stuck onto the second optically-transparent-resin thin-film layer 30 via a 50 μm-thick optically-transparent adhesive layer 28 using a sheet adhesive (made by Nitto Denko).

Accordingly, a sample-4 second intermediate disk structure M2 was produced with no damage to the second recording layer 32, such as shown in FIG. 4, but with the second optically-transparent substrate 54 via the optically-transparent adhesive layer 28.

The optically-transparent substrate 54 and the optically-transparent adhesive layer 28 correspond to the optically-transparent layer 60 shown in FIG. 14.

Reflectivity was evaluated for the sample-4 second intermediate disk structure M2 with the DVD evaluator (DDU-1000 made by Pulse Tech Co.).

The sample-4 second intermediate disk structure M2 exhibited 51% in reflectivity higher than 50%, thus showing a preferable result.

A sample-4 first intermediate disk structure M1 produced in the same way as the counterpart M1 of the sample 3 and the sample-4 second intermediate disk structure M2 were stuck to each other via a 50 μm-thick optically-transparent adhesive layer 28 using a sheet adhesive (made by Nitto Denko), thus a sample-4 dual-layer optical disk was produced as the sample 4.

Recording and reproduction characteristics were evaluated for the sample-4 optical disk with a DVD-R evaluator at 658 nm in laser wavelength and 0. 65 in lens NA.

The sample-4 second intermediate disk structure M2 exhibited 18. 2% in reflectivity, practically enough for a storage medium.

The further evaluation results were as follows: 56 dB in C/N and 65% in modulation factor for the first recording layer 24; 50 dB in C/N and 58% in modulation factor for the second recording layer 32; and 18% and higher in reflectivity against 650 nm-wavelength laser for both recording layers. This reflectivity lies within the standard specification of read-only dual-layer DVD (so-called DVD dual layer). It was then confirmed that this sample-4 optical disk is compatible with read-only dual-layer DVD in reflectivity.

In terms of reflectivity, the sample-1, -1a and -1b optical disks according to the present invention exhibited 18% or higher for both of the first and the second intermediate disk structures M1 and M2 after bonded even though they were produced with spin coating. Thus, these sample optical disks are compatible with read-only dual-layer DVD in reflectivity.

### COMPARATIVE SAMPLE 3

A reflective layer 34 was formed on a second substrate 36 in the same way as the samples 3 and 4.

A second organic-dye recording layer 32 was formed on the reflective layer 34, as follows:

In detail, cyanine (exhibiting 555 nm in maximum absorption wavelength λmax in dichloromethane solution) having almost same optical characteristics as phthalocyanine (used in the samples 3 and 4) was dissolved in tetrafluoropropanol to prepare a 0. 75-wt % solution.

The solution was applied on the reflective layer 34, followed by spin coating at 1000 rpm, different from vacuum deposition in the samples 3 and 4. Thus, the second organic-dye recording layer 32 was formed.

An optically-transparent thin-film layer 60 was then formed on the second organic-dye recording layer 32 in the same way as the second optically-transparent-resin thin-film layer 30 in the sample 4.

The second recording layer 32 (the comparative sample 3) formed as above had a film thicknesses of 60 nm on lands 64A and 25 nm on grooves. These film thicknesses give Rg−Dg=25 nm and R1−D1=60 nm, which do not satisfy the relational expression Rg−Dg≧R1−D1. The film thickness of the lands 64A was thicker than that of the grooves 64B in the comparative sample 3. This thickness relationship is opposite of that in the samples 3 and 4.

An optically-transparent substrate was then stuck onto the optically-transparent-resin thin-film layer 60 via an optically-transparent adhesive layer, in the same way as the sample 4. Thus, a second intermediate disk structure Mc2 (comparative sample 3) was produced, but with the optically-transparent-resin thin-film layer 60 via the optically-transparent adhesive layer for evaluation of reflectivity.

Reflectivity was evaluated for the second intermediate disk structure Mc2 (comparative sample 3) with the DVD evaluator (DDU-1000 made by Pulse Tech Co.).

The second intermediate disk structure Mc2 (comparative sample 3) exhibited terribly low reflectivity of 21% before bonded.

The second intermediate disk structure Mc2 (comparative sample 3) was stuck to a first intermediate disk structure Mc1 (comparative sample 3) produced in the same as in the samples 3 and 4, thus a dual-layer optical disk (comparative sample 3) was produced.

The dual-layer optical disk (comparative sample 3) exhibited reflectivity far below 18%, thus not incompatible with read-only dual-layer DVD in reflectivity.

As disclosed above in detail, through the comparison of several samples according to the present invention and comparative samples, it is stated that the present invention achieves high reflectivity and also high modulation factor for dual-layer optical disks with no damage to organic recording layers.

Moreover, the optical disks produced in accordance with the present invention are compatible with read-only dual-layer DVD in reflectivity as discussed above, and hence can be played back on ordinary DVD players, a large number of which have already been shipped.

1. An optical disk comprising:
a first intermediate disk structure having at least a first optically-transparent substrate and a first recording layer, laminated in order;
a second intermediate disk structure having at least a second substrate, a reflective layer, a second recording layer and a first optically-transparent-resin thin-film layer, laminated in order, the second recording layer having an organic dye soluble in an alcohol solution or a Cellosolve solution, the first optically-transparent-resin thin-film layer having a thermoplastic resin that is softened and deformed at a particular temperature or lower at which the organic dye of the second recording layer is decomposed when absorbing an irradiated laser beam in recording; and
an optically-transparent adhesive layer, the first and the second intermediate disk structures being stuck to each other via the adhesive layer as the first recording layer and the first optically-transparent-resin thin-film layer face each other via the adhesive layer in which the first optically-transparent-resin thin-film layer directly comes into contact with the adhesive layer.

2. The optical disk according to claim 1 wherein the thermoplastic resin of the first optically-transparent-resin thin-film layer is an alicyclic hydrocarbon resin, a cyclo-olefin polymer or an amorphous cyclo-olefin copolymer, soluble in a solution that does not dissolve the organic dye of the second recording layer.

3. The optical disk according to claim 1 wherein the first and the second recording layers are made of materials exhibiting different spectral characteristics.

4. The optical disk according to claim 1 wherein the second recording layer has a guide groove formed thereon as facing the first optically-transparent-resin thin-film layer, the guide groove having concave sections and convex sections, optical-path distances from a light-incident plane of the first optically-transparent substrate through which the laser beam is incident to the concave and the convex sections satisfy a relational expression D1−Dg≧R1−Rg in which D1 is a distance from the light-incident plane to an interface of the second recording layer on the convex sections, Dg is a distance from the light-incident plane to an interface of the second recording layer on the concave sections, R1 is a distance from the light-incident plane to an interface of the reflective layer on the convex sections, and Rg is a distance from the light-incident plane to an interface of the reflective layer on the concave sections.

5. The optical disk according to claim 1 wherein the second intermediate disk structure has a second optically-transparent-resin thin-film layer, the second recording layer being sandwiched by the first and the second optically-transparent-resin thin-film layers.

6. The optical disk according to claim 1 wherein the first intermediate disk structure has a second optically-transparent-resin thin-film layer on the first recording layer, thus the first optically-transparent substrate, the first recording layer and the second optically-transparent-resin thin-film layer being laminated in order, the first and the second intermediate disk structures being stuck to each other via the adhesive layer as the first and the second optically-transparent-resin thin-film layers face each other via the adhesive layer.

7. The optical disk according to claim 1 wherein the first intermediate disk structure has a semi-transparent reflective layer and an optically-transparent dielectric layer on the first recording layer, thus the first optically-transparent substrate, the first recording layer, the semi-transparent reflective layer and the optically-transparent dielectric layer being laminated in order, the first and the second intermediate disk structures being stuck to each other via the adhesive layer as the optically-transparent dielectric layer and the first optically-transparent-resin thin-film layer face each other via the adhesive layer.

8. A method of producing an optical disk comprising the steps of:
forming at least a first recording layer on a first optically-transparent substrate to form a first intermediate disk structure;
forming at least a reflective layer and a second recording layer in order on a second substrate;
spin coating the second recording layer with a first optically-transparent-resin thin-film layer having a thermoplastic resin that is softened and deformed at a particular temperature or lower at which the second recording layer is decomposed when absorbing an irradiated laser beam in recording, to form a second intermediate disk structure having the second substrate, the reflective layer, the second recording layer and the first optically-transparent-resin thin-film layer, laminated in order; and
bonding the first and the second intermediate disk structures each other via an optically-transparent adhesive layer so that the first recording layer and the first optically-transparent-resin thin-film layer face each other via the adhesive layer in which the first optically-transparent-resin thin-film layer directly comes into contact with the adhesive layer.

9. The method according to claim 8 further comprising the step of forming the second recording layer with an organic dye soluble in an alcohol solution or a Cellosolve solution.

10. The method according to claim 9 further comprising the step of forming the first optically-transparent-resin thin-film layer with spin coating of an alicyclic hydrocarbon resin, a cyclo-olefin polymer or an amorphous cyclo-olefin copolymer, soluble in a solution that does not dissolve the organic dye of the second recording layer.

11. The method according to claim 8 further comprising the step of forming the second recording layer with a material exhibiting spectral characteristics different from the first recording layer.

12. The method according to claim 8 further comprising the step of forming a guide groove having concave sections and convex sections on the second recording layer so that the guide groove faces the first optically-transparent-resin thin-film layer, optical-path distances from a light-incident plane of the first optically-transparent substrate through which the laser beam is incident to the concave and the convex sections satisfying a relational expression D1−Dg≧R1−Rg in which D1 is a distance from the light-incident plane to an interface of the second recording layer on the convex sections, Dg is a distance from the light-incident plane to an interface of the second recording layer on the concave sections, R1 is a distance from the light-incident plane to an interface of the reflective layer on the convex sections, and Rg is a distance from the light-incident plane to an interface of the reflective layer on the concave sections.

13. The method according to claim 8 further comprising the step of forming a second optically-transparent-resin thin-film layer on the first recording layer so that the first optically-transparent substrate, the first recording layer and the second optically-transparent-resin thin-film layer are laminated in order, the first and the second intermediate disk structures being stuck to each other via the adhesive layer as the first and the second optically-transparent-resin thin-film layers face each other via the adhesive layer.

14. The method according to claim 8 further comprising the step of forming a semi-transparent reflective layer and an optically-transparent dielectric layer on the first recording layer so that the first optically-transparent substrate, the first recording layer, the semi-transparent reflective layer and the optically-transparent dielectric layer are laminated in order, the first and the second intermediate disk structures being stuck to each other via the adhesive layer as the optically-transparent dielectric layer and the first optically-transparent-resin thin-film layer face each other via the adhesive layer.
